(19) United States
(12) Patent Application Publication
(10) Pub. No.: US 2026/0252627 A1
(43) Pub. Date: Aug. 27, 2026

(54) ARTIFICIAL INTELLIGENCE CONVERSATION PROCESSING APPARATUS AND METHOD

(71) Applicants: Jae Ho CHOI, Seoul (KR); Delta PDS Co., Ltd., Seoul (KR)

(72) Inventor: Jae Ho CHOI, Seoul (KR)

(73) Assignees: Jae Ho CHOI, Seoul (KR); Delta PDS Co., Ltd., Seoul (KR)

(21) Appl. No.: 19/544,402

(22) Filed: Feb. 19, 2026

(30) Foreign Application Priority Data
Feb. 27, 2025 (KR) 10-2025-0025560
Feb. 28, 2025 (KR) 10-2025-0026312
Dec. 17, 2025 (KR) 10-2025-0202128

(51) Int. Cl. G06F 16/9032; G06F 16/9038; G06F 40/35; G06N 3/042; H04L 51/02

(52) U.S. Cl. CPC G06F 16/90332; G06F 16/9038; G06F 40/35; G06N 3/042; H04L 51/02

(57) ABSTRACT

An artificial intelligence (AI) conversation processing apparatus includes an AI conversation room generation unit, a retrieval-augmented interface unit that generates a retrieval-augmented interface for setting a retrieval-augmented conversation room to be utilized in an AI conversation room, a retrieval-augmented query generation unit that receives a user conversation message in the AI conversation room and generates a retrieval-augmented query that can be utilized to search past conversation history of the retrieval-augmented conversation room, an AI conversation message generation unit that searches the past conversation history and inputs the user conversation message and the searched past conversation history to the AI conversation agent as an integrated input prompt to generate an AI conversation message, and an AI conversation response unit that provides the AI conversation message to the AI conversation room as a response to the user conversation message by the AI conversation agent.

### CROSS-REFERENCE TO RELATED APPLICATION

This application claims the benefit of and priority to Korean Patent Application Nos. 10-2025-0025560, filed on Feb. 27, 2025, 10-2025-0026312, filed on Feb. 28, 2025, and 10-2025-0202128, filed on Dec. 17, 2025, the entire disclosure(s) of which is hereby incorporated herein by reference in its entirety.

### TECHNICAL FIELD

The present disclosure relates to the field of artificial intelligence and communication technologies, and more particularly, to an artificial intelligence conversation processing apparatus and method capable of performing question-and-answer interactions in an artificial intelligence conversation room based on information and content of a retrieval-augmented conversation room selected by a user, and providing responses suitable for a context of a conversation by allowing a plurality of artificial intelligence conversation agents generated according to search options to participate in a user conversation room.

### BACKGROUND

In modern society, utilization of digital communication tools has rapidly increased in various fields such as remote work, global collaboration, and customer support. These tools provide text-based conversation rooms capable of exchanging messages in real time, file sharing, and video conferencing functions, thereby supporting smooth communication among users. In particular, in project management and team collaboration environments, information sharing and decision-making are efficiently performed through conversation rooms in which a plurality of team members simultaneously participate.

However, existing conversation tools exhibit several limitations in supporting efficient information exchange and collaboration among users. For example, in conversation rooms in which a large number of users participate, it may be difficult to quickly search for and provide necessary information, and there is a lack of functionality for providing useful information at an appropriate time without interrupting a flow of a conversation. In addition, real-time support capable of immediately responding to user demands is insufficient, such that important information may be omitted or delays may occur in a decision-making process.

In particular, functions for selectively utilizing text, image, audio, or file-based data stored in a specific conversation room according to search options, or for clearly providing evidence of an artificial intelligence-generated response by linking the response to a related conversation block, are insufficient in the prior art. Accordingly, there is an increasing need for retrieval-augmentation-based conversation processing technology capable of searching for and presenting information related to a user query in real time while maintaining continuity of a conversation.

Korean Patent Application Publication No. 10-2024-0007989 (published on Jan. 18, 2024) provides an integrated chatbot service that integrates a plurality of chatbot groups into one to accurately search for and provide content matching a user intent, and improves appropriateness of search results through additional search keyword recommendations.

The integrated chatbot-based service providing method includes receiving a query from a user device by an integrated chatbot, extracting main keywords from the query, transmitting the extracted keywords to a first chatbot and a second chatbot, deriving content search results related to the main keywords from each chatbot, and providing a response to the query to the user device based on the derived search results.

### PRIOR ART REFERENCES

### Patent Document

Korean Patent Application Publication No. 10-2024-0007989 (published on Jan. 18, 2024)

### SUMMARY

One embodiment of the present invention is intended to provide an artificial intelligence conversation processing apparatus and method capable of generating an artificial intelligence conversation room and allowing an artificial intelligence conversation agent to generate a response suitable for a context of a conversation based on information and content of a retrieval-augmented conversation room selected by a user.

One embodiment of the present invention is intended to provide an artificial intelligence conversation processing apparatus and method capable of configuring a retrieval-augmented conversation room from among a plurality of conversation rooms in which a user participates and providing a retrieval-augmented interface through which a search interval or a search topic can be selected, thereby constructing a search environment suitable for user requirements.

One embodiment of the present invention is intended to provide an artificial intelligence conversation processing apparatus and method capable of generating a retrieval-augmented query based on a user conversation message and searching past conversation history of a retrieval-augmented conversation room using the generated retrieval-augmented query, thereby improving response accuracy and contextual relevance of an artificial intelligence conversation agent.

One embodiment of the present invention is intended to provide an artificial intelligence conversation processing apparatus and method capable of assigning a response evidence link to a conversation block selected according to a retrieval-augmented query and allowing a user to directly access related information through the response evidence link presented together with an artificial intelligence conversation message, thereby enabling confirmation of evidence-based responses within a flow of a conversation.

One embodiment of the present invention is intended to provide an artificial intelligence conversation processing apparatus and method that provides a function allowing a user to edit an artificial intelligence response or the user's own conversation message during a process of providing an artificial intelligence conversation message, thereby securing user controllability over a response generation process of artificial intelligence and enabling real-time information refinement and reflection in a collaborative environment.

One embodiment of the present invention is intended to provide an artificial intelligence conversation processing apparatus and method that provides a structure capable of generating a new artificial intelligence conversation room reflecting changed settings when search options are changed or a configuration of a retrieval-augmented conversation room is changed, thereby flexibly utilizing a plurality of artificial intelligence conversation agents suitable for various collaboration scenarios.

In one embodiment, an artificial intelligence conversation processing apparatus includes an artificial intelligence conversation room generation unit configured to generate an artificial intelligence conversation room in which an artificial intelligence conversation agent capable of responding to a user's conversation participates, a retrieval-augmented interface unit configured to generate a retrieval-augmented interface for setting a retrieval-augmented conversation room to be utilized in the artificial intelligence conversation room, wherein the retrieval-augmented conversation room is configured as a participating conversation room of the user, a retrieval-augmented query generation unit configured to receive a user conversation message in the artificial intelligence conversation room and to generate a retrieval-augmented query that can be utilized to search past conversation history of the retrieval-augmented conversation room, an artificial intelligence conversation message generation unit configured to search the past conversation history of the retrieval-augmented conversation room through the retrieval-augmented query and to input the user conversation message and the searched past conversation history to the artificial intelligence conversation agent as an integrated input prompt to generate an artificial intelligence conversation message and an artificial intelligence conversation response unit configured to provide the artificial intelligence conversation message to the artificial intelligence conversation room as a response to the user conversation message by the artificial intelligence conversation agent.

The artificial intelligence conversation agent may be invited by the user so as to simultaneously participate in another participating conversation room of the user.

The retrieval-augmented interface unit may be configured to set a search interval or a search topic for the retrieval-augmented conversation room through the retrieval-augmented interface.

The retrieval-augmented interface unit may be configured to connect a retrieval-augmented extension agent that controls searching and answering with respect to an external database through the retrieval-augmented interface.

The retrieval-augmented interface unit may be configured to generate a new artificial intelligence conversation room when a search interval or a search topic for the retrieval-augmented conversation room is changed through the retrieval-augmented interface, or when the retrieval-augmented extension agent is changed.

The retrieval-augmented interface unit may be configured to add or cancel the retrieval-augmented conversation room through the retrieval-augmented interface.

The retrieval-augmented query generation unit may be configured to determine whether the user conversation message belongs to a search topic of the retrieval-augmented conversation room and to determine whether to generate the retrieval-augmented query based on the determination.

In one embodiment, when generation of the retrieval-augmented query fails, the retrieval-augmented query generation unit may be configured to determine whether to receive support from another artificial intelligence conversation agent in another artificial intelligence conversation room set to another search topic having relevance to the retrieval-augmented query.

The artificial intelligence conversation message generation unit may be configured to select a conversation block corresponding to the retrieval-augmented query from the past conversation history of the retrieval-augmented conversation room, to assign a response evidence link to the selected conversation block, and to utilize the conversation block and the response evidence link in generation of the integrated input prompt.

The artificial intelligence conversation message generation unit may be configured to provide the artificial intelligence conversation message together with the response evidence link through the artificial intelligence conversation agent and to allow contents of the conversation block to be confirmed through user interaction.

The artificial intelligence conversation response unit may be configured to directly modify the artificial intelligence conversation message through edit control of the user during a process of providing the artificial intelligence conversation message.

The artificial intelligence conversation response unit may be configured to modify the user conversation message through edit control of the user during a process of providing the artificial intelligence conversation message so that the artificial intelligence conversation agent indirectly modifies the artificial intelligence conversation message.

In one embodiment, a method for artificial intelligence conversation processing performed in an artificial intelligence conversation processing apparatus, the method includes generating an artificial intelligence conversation room in which an artificial intelligence conversation agent capable of responding to a user's conversation participates, generating a retrieval-augmented interface for setting a retrieval-augmented conversation room to be utilized in the artificial intelligence conversation room, wherein the retrieval-augmented conversation room is configured as a participating conversation room of the user, receiving a user conversation message in the artificial intelligence conversation room and generating a retrieval-augmented query that can be utilized to search past conversation history of the retrieval-augmented conversation room, searching the past conversation history of the retrieval-augmented conversation room through the retrieval-augmented query and inputting the user conversation message and the searched past conversation history to the artificial intelligence conversation agent as an integrated input prompt to generate an artificial intelligence conversation message; and providing the artificial intelligence conversation message to the artificial intelligence conversation room as a response to the user conversation message by the artificial intelligence conversation agent.

### ADVANTAGEOUS EFFECTS

The disclosed technology may have the following effects. However, this does not mean that a specific embodiment must include all of the following effects or must include only the following effects, and therefore, the scope of rights of the disclosed technology should not be understood as being limited thereby.

The artificial intelligence conversation processing apparatus and method can generate an artificial intelligence conversation room and allow an artificial intelligence conversation agent to generate a response suitable for a context of a conversation based on information and content of a retrieval-augmented conversation room selected by a user.

The artificial intelligence conversation processing apparatus and method can configure a retrieval-augmented conversation room from among a plurality of conversation rooms in which a user participates and provide a retrieval-augmented interface through which a search interval or a search topic can be selected, thereby constructing a search environment suitable for user requirements.

The artificial intelligence conversation processing apparatus and method can generate a retrieval-augmented query based on a user conversation message and search past conversation history of a retrieval-augmented conversation room using the generated retrieval-augmented query, thereby improving response accuracy and contextual relevance of an artificial intelligence conversation agent.

The artificial intelligence conversation processing apparatus and method can assign a response evidence link to a conversation block selected according to a retrieval-augmented query and allow a user to directly access related information through the response evidence link presented together with an artificial intelligence conversation message, thereby enabling confirmation of evidence-based responses within a flow of a conversation.

The artificial intelligence conversation processing apparatus and method can provide a function allowing a user to edit an artificial intelligence response or the user's own conversation message during a process of providing an artificial intelligence conversation message, thereby securing user controllability over a response generation process of artificial intelligence and enabling real-time information refinement and reflection in a collaborative environment.

The artificial intelligence conversation processing apparatus and method can provide a structure capable of generating a new artificial intelligence conversation room reflecting changed settings when search options are changed or a configuration of a retrieval-augmented conversation room is changed, thereby flexibly utilizing a plurality of artificial intelligence conversation agents suitable for various collaboration scenarios.

### BRIEF DESCRIPTION OF THE DRAWINGS

FIG. 1 is a diagram illustrating an artificial intelligence conversation processing system according to one embodiment of the present invention.

FIG. 2 is a diagram illustrating a system configuration of the artificial intelligence conversation processing apparatus of FIG. 1.

FIGS. 3A and 3B are diagrams illustrating a functional configuration of the artificial intelligence conversation processing apparatus of FIG. 1.

FIG. 4 is a flowchart illustrating an artificial intelligence conversation processing method performed in the artificial intelligence conversation processing apparatus of FIG. 1.

FIGS. 5A and 5B are diagrams illustrating a process of generating and utilizing conversation data in the artificial intelligence conversation processing apparatus of FIG. 1.

FIGS. 6A to 6C are diagrams illustrating an example of a user interface (UI) configuration implemented in the artificial intelligence conversation processing apparatus of FIG. 1.

### DETAILED DESCRIPTION

Since the description of the present disclosure is merely an embodiment for illustrating structural or functional description, it should not be interpreted that the technical scope of the present disclosure is limited by the embodiments described in this document. In other words, embodiments may be modified in various ways and implemented in various forms; therefore, it should be understood that various equivalents realizing technical principles of the present disclosure belong to the technical scope of the present disclosure. Also, since it is not meant that a specific embodiment should support all of the purposes or effects intended by the present disclosure or include only the purposes or effects, the technical scope of the present disclosure should not be regarded as being limited to the descriptions of the embodiment.

Meanwhile, implication of the terms used in this document should be understood as follows.

The terms such as “first” and “second” are introduced to distinguish one element from the others, and thus the technical scope of the present disclosure should not be limited by those terms. For example, a first element may be called a second element, and similarly, the second element may be called the first element.

Suppose a constituting element is said to be “connected” to another constituting element. In that case, the former may be connected to the latter element directly, but it should be understood that a third constituting element may be present between the two elements. On the other hand, if a constituting element is said to be “directly connected” to another constituting element, it should be understood that there is no other constituting element present between the two elements. Meanwhile, other expressions describing a relationship between constituting elements, namely “between” and “right between” or “adjacent to” and “directly adjacent to” should be interpreted to provide the same implication.

A singular expression should be understood to indicate a plural expression unless otherwise explicitly stated. The term “include” or “have” is used to indicate existence of an embodied feature, number, step, operation, constituting element, component, or a combination thereof; and should not be understood to preclude the existence or possibility of adding one or more other features, numbers, steps, operations, constituting elements, components, or a combination thereof.

Identification symbols (e.g., a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices that store data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

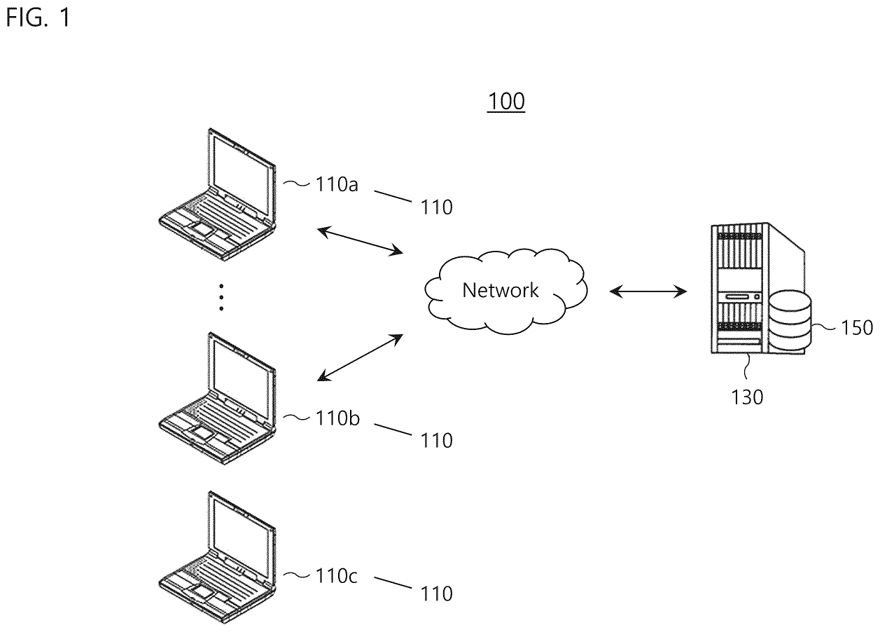

FIG. 1 is a diagram illustrating an artificial intelligence conversation processing system according to one embodiment of the present invention.

Referring to FIG. 1, an artificial intelligence conversation processing system 100 may include a plurality of user terminals 110, an artificial intelligence conversation processing apparatus 130, and a database 150.

The user terminal 110 may correspond to a computing device operated by a user. The user terminal 110 may be implemented as a desktop computer, a laptop computer, a tablet PC, or a smartphone, and may be configured as various electronic devices. The user terminal 110 may include at least one of a first user terminal 110a, a second user terminal 110b, and a third user terminal 110c.

The user terminal 110 may perform a function of allowing a user to create a new conversation room or to exchange and share information such as text, images, audio, and files in an existing participating conversation room. The user may set at least one of the existing participating conversation rooms as a retrieval-augmented conversation room, such that the artificial intelligence conversation processing apparatus 130 is configured to search past conversation history of the corresponding conversation room and generate an artificial intelligence conversation message.

The user terminal 110 may be implemented as a mobile device or a desktop device, and may be connected to the artificial intelligence conversation processing apparatus 130 through cellular communication, Wi-Fi communication, or Internet communication.

The artificial intelligence conversation processing apparatus 130 is a computing device connected to the user terminal 110 through a network, and may perform functions of generating an artificial intelligence conversation room, providing a retrieval-augmented interface, generating a retrieval-augmented query, and generating an artificial intelligence conversation message. The artificial intelligence conversation processing apparatus 130 may analyze past conversation history of a retrieval-augmented conversation room in cooperation with the user terminal 110, and may generate an artificial intelligence conversation message suitable for a context of a conversation through an artificial intelligence-based response generation function.

The artificial intelligence conversation processing apparatus 130 may analyze a user conversation message, search conversation blocks stored in a retrieval-augmented conversation room to construct context information required for response generation, and generate an artificial intelligence conversation message including a response evidence link.

The artificial intelligence conversation processing apparatus 130 may be interoperable with the user terminal 110 through a dedicated program installed in the user terminal 110 or a web-based agent, and may perform data synchronization and computational processing according to user approval.

The database 150 is a storage device that stores various data utilized in a process in which the artificial intelligence conversation processing apparatus 130 generates an artificial intelligence conversation message. The database 150 may store user conversation messages, retrieval-augmented queries, searched conversation blocks, response evidence links, user configuration information, and analyzed information.

In addition, although the database 150 is illustrated in FIG. 1 as a logical storage device included in the artificial intelligence conversation processing apparatus 130, the database 150 is not limited thereto, and may be implemented as a separate independent storage device or a cloud-based database.

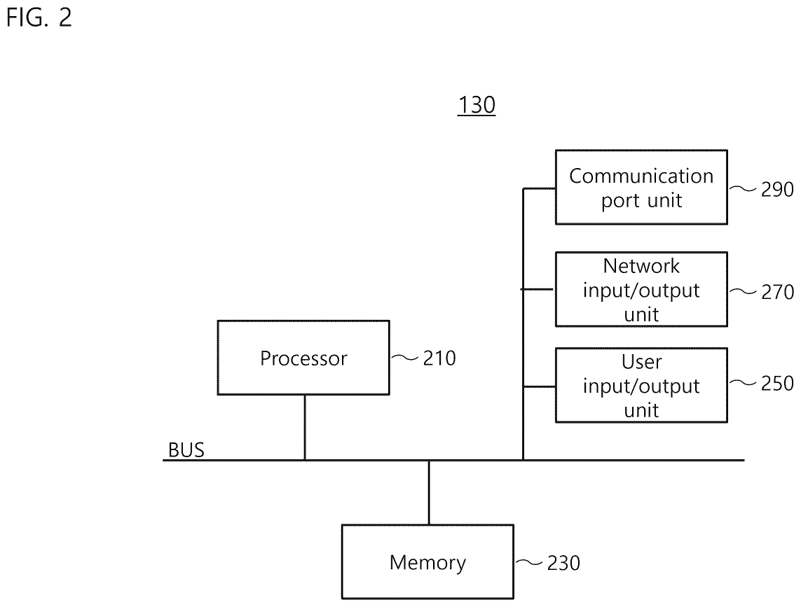

FIG. 2 is a diagram illustrating a system configuration of the artificial intelligence conversation processing apparatus of FIG. 1.

Referring to FIG. 2, the artificial intelligence conversation processing apparatus 130 may include a processor 210, a memory 230, a user input/output unit 250, a network input/output unit 270, and a communication port unit 290.

The processor 210 controls overall operations of the artificial intelligence conversation processing apparatus 130, and may manage data flow by interacting with the memory 230, the user input/output unit 250, the network input/output unit 270, and the communication port unit 290. The processor 210 executes data processing procedures of the artificial intelligence conversation processing apparatus 130, manages data of the memory 230 that are read or written during the execution, and may schedule synchronization timing between volatile memory and non-volatile memory included in the memory 230.

In addition, the processor 210 may control processes of generating an artificial intelligence conversation room according to a user request, setting a retrieval-augmented interface, selecting or changing a retrieval-augmented conversation room, generating a retrieval-augmented query, analyzing past conversation history of a retrieval-augmented conversation room, generating an artificial intelligence conversation message, and providing a response. For example, when a setting of a retrieval-augmented conversation room is changed, the processor 210 may determine whether to generate a new artificial intelligence conversation room and may perform a function of configuring a response evidence link based on searched conversation blocks. The processor 210 may be implemented as a CPU (Central Processing Unit) or a GPU (Graphics Processing Unit) of the artificial intelligence conversation processing apparatus 130, and a data processing throughput may be adjusted according to computational performance of the apparatus.

The memory 230 may include an auxiliary storage device implemented as non-volatile memory such as an SSD (Solid State Disk) or an HDD (Hard Disk Drive), and a main storage device implemented as volatile memory such as RAM (Random Access Memory). In addition, the memory 230 stores an instruction set of data processing procedures executed by the processor 210, and may store retrieval-augmented conversation room configuration information, retrieval-augmented queries, searched conversation blocks, response evidence links, user conversation messages, artificial intelligence conversation messages, and user edit information, and may retrieve the stored information as needed to support response generation. The memory 230 may record user input data provided in a retrieval-augmented query generation process, past conversation history of a retrieval-augmented conversation room, and response information generated by an artificial intelligence conversation agent, thereby performing a function of supporting operations of the artificial intelligence conversation processing apparatus 130.

The user input/output unit 250 is a device for receiving user input and outputting information, and may include input devices such as a touch pad, a touch screen, a virtual keyboard, or a pointing device, and output devices such as a monitor or a touch screen. The user input/output unit 250 may perform a function of receiving a user query through the artificial intelligence conversation processing apparatus 130 and outputting a retrieval-augmented interface, searched conversation blocks, an artificial intelligence conversation message, and a response evidence link. In addition, the user input/output unit 250 may provide a question-and-answer interface for the artificial intelligence conversation processing apparatus 130 in cooperation with a user terminal even in a remote access environment.

The network input/output unit 270 provides a communication environment for connection with a user terminal, and may include network interfaces such as a LAN (Local Area Network), a MAN (Metropolitan Area Network), a WAN (Wide Area Network), and a VAN (Value Added Network). In addition, the network input/output unit 270 may be connected to the user terminal through short-range wireless communication functions such as Wi-Fi or Bluetooth, or through a mobile communication network of 4G or higher, and may perform a function of transmitting a retrieval-augmented query, a search request, searched conversation blocks, an artificial intelligence conversation message, and a response evidence link to the user terminal.

The communication port unit 290 may be implemented as a module that performs port mapping or routing functions in a process of transmitting and receiving data through a network. The communication port unit 290 may dynamically manage a source port and a destination port to distinguish sessions in a process of transmitting user query and response data, prevent data collision, and optimize network load. In addition, the communication port unit 290 may set priorities of data packets to optimize transmission speed of an artificial intelligence conversation message and a response evidence link.

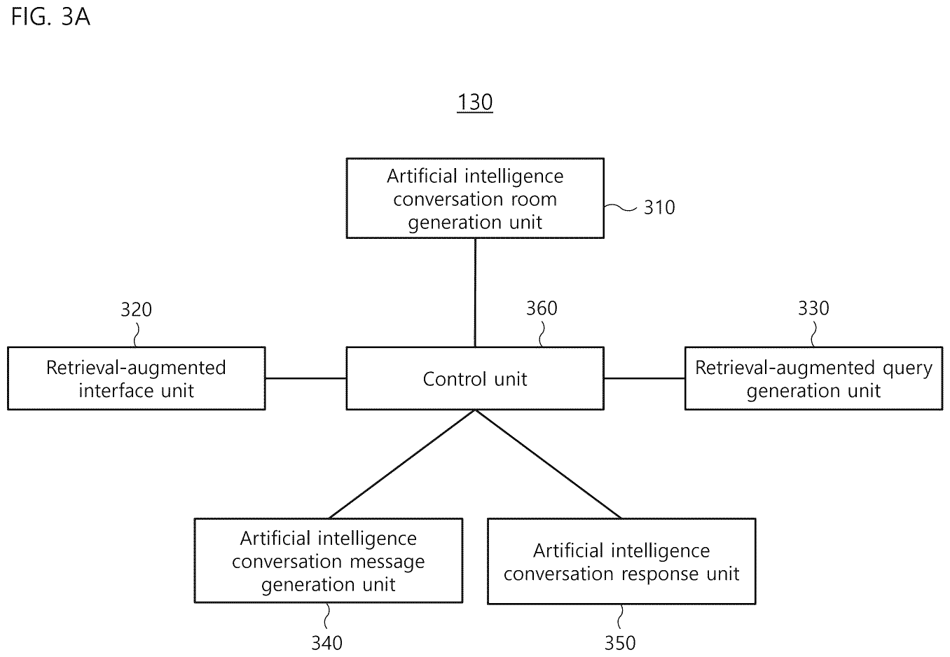

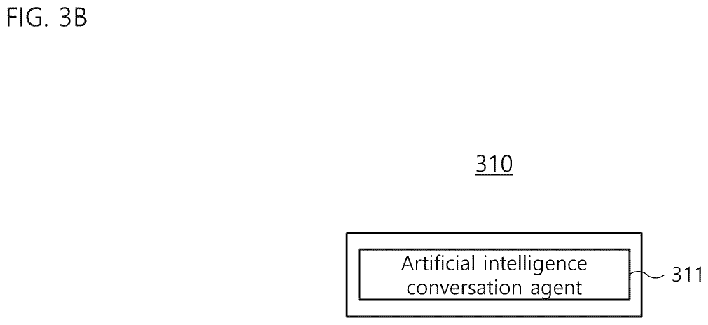

FIGS. 3A and 3B are diagrams illustrating a functional configuration of the artificial intelligence conversation processing apparatus of FIG. 1.

Referring to FIGS. 3A and 3B, the artificial intelligence conversation processing apparatus 130 includes an artificial intelligence conversation room generation unit 310, a retrieval-augmented interface unit 320, a retrieval-augmented query generation unit 330, an artificial intelligence conversation message generation unit 340, an artificial intelligence conversation response unit 350, and a control unit 360. In addition, the artificial intelligence conversation room generation unit 310 includes an artificial intelligence conversation agent 311.

In this regard, embodiments of the present invention are not required to include all of the above functional configurations simultaneously, and according to each embodiment, some of the above configurations may be omitted, or some or all of the above configurations may be selectively included for implementation. In addition, one embodiment of the present invention may be implemented as an independent module selectively including some of the above configurations, and an artificial intelligence conversation processing method may be performed through interoperation among the modules. Hereinafter, operations of each configuration will be described in detail.

The artificial intelligence conversation room generation unit 310 may generate an artificial intelligence conversation room in which an artificial intelligence conversation agent 311 capable of responding to a user conversation participates. Here, the artificial intelligence conversation agent 311 is a response generation module based on a language model that has been trained in advance to process a conversation with a user, and may be registered as an initial participant of the conversation room by the artificial intelligence conversation room generation unit 310. The artificial intelligence conversation agent 311 may receive user messages in real time within the conversation room and may generate an artificial intelligence conversation message by performing message analysis, intent interpretation, and conversation context tracking. In addition, even when simultaneously participating in a plurality of conversation rooms having different purposes, the artificial intelligence conversation agent 311 may be configured to independently maintain a context for each conversation room, and an operation mode may be set according to a role required in each conversation room, such as business consultation, knowledge search-based explanation, or meeting summarization. The artificial intelligence conversation agent 311 may be controlled to dynamically participate in a new conversation room according to invitation information, or to generate an additional response while maintaining a conversation context in an existing conversation room.

The artificial intelligence conversation room generation unit 310 may receive a request for generating an artificial intelligence conversation room from a user terminal 110 and may configure an artificial intelligence conversation room in which the artificial intelligence conversation agent 311 is registered as an initial participant. In addition, the artificial intelligence conversation room generation unit 310 may perform a function of inviting the artificial intelligence conversation agent 311 to another conversation room in which a user participates so that the artificial intelligence conversation agent 311 simultaneously participates.

The artificial intelligence conversation room generation unit 310 may interpret a conversation room generation request input from the user terminal 110 and may configure conversation room properties. The configured properties may include a type of the artificial intelligence conversation agent 311, a conversation room identifier, and user participation information. The artificial intelligence conversation room generation unit 310 may register the artificial intelligence conversation agent 311 as an initial participant at a time of generating the conversation room so that response processing for a user conversation message can be performed. In addition, the artificial intelligence conversation room generation unit 310 may manage a plurality of artificial intelligence conversation rooms simultaneously and may configure invitation information such that the artificial intelligence conversation agent 311 participates in the plurality of conversation rooms in parallel. The invitation information may be generated according to a user request or internal analysis of a conversation flow of the system.

In one embodiment according to the claims, the artificial intelligence conversation room generation unit 310 may receive a conversation room generation request from the user terminal 110 as an input. The artificial intelligence conversation room generation unit 310 may register a new artificial intelligence conversation room based on the request and may set the artificial intelligence conversation agent 311 as an initial participant. The artificial intelligence conversation room generation unit 310 may assign a conversation room identifier to the generated artificial intelligence conversation room and may manage the artificial intelligence conversation room so as to be independently operated.

In another embodiment, the artificial intelligence conversation room generation unit 310 may receive a request from the user terminal 110 to invite the artificial intelligence conversation agent 311 as an additional participant to a specific conversation room. In this case, the artificial intelligence conversation room generation unit 310 may set the artificial intelligence conversation agent 311 to participate in a new conversation room in addition to an existing conversation room in which the artificial intelligence conversation agent 311 is already participating. The artificial intelligence conversation agent 311 configured in this manner may receive user messages and generate responses simultaneously in the plurality of conversation rooms.

In an embodiment other than the claims, the artificial intelligence conversation room generation unit 310 may perform a function of proposing generation of a new artificial intelligence conversation room by analyzing a recent message pattern of a user or a specific task topic. For example, when a user repeatedly mentions a specific project name or a document task topic, the artificial intelligence conversation room generation unit 310 may provide a guidance message to the user recommending an artificial intelligence conversation room configuration suitable for the corresponding topic. When the user approves the proposal, the artificial intelligence conversation room generation unit 310 may automatically generate a new artificial intelligence conversation room with the recommended configuration.

In another embodiment, the artificial intelligence conversation room generation unit 310 may conditionally generate an artificial intelligence conversation room by referring to external context information such as a user location, schedule information, or device status. For example, when a user enters a meeting room according to a meeting schedule, the artificial intelligence conversation room generation unit 310 may automatically generate an artificial intelligence conversation room for meeting records and may set the artificial intelligence conversation agent 311 as a participant. In addition, the artificial intelligence conversation room generation unit 310 may configure a hierarchical conversation environment in which an upper-level conversation room and a lower-level conversation room are operated in a multi-stage structure. The upper-level conversation room may be set to handle an overall project summary, and the lower-level conversation room may be set to process an individual task flow, and the artificial intelligence conversation agent 311 may provide a response by referring to both the upper-level structure and the lower-level structure.

The retrieval-augmented interface unit 320 performs a role of setting a search environment and a search target scope for applying a retrieval-augmented function in an artificial intelligence conversation room, and may function as an upper-level configuration module that defines an overall search scope to be referenced by the retrieval-augmented query generation unit 330 and the artificial intelligence conversation message generation unit 340.

The retrieval-augmented interface unit 320 may generate a retrieval-augmented conversation room configuration interface on the user terminal 110, and may provide an environment in which a user can select, from among a plurality of conversation rooms in which the user participates, a retrieval-augmented conversation room to be utilized for the retrieval-augmented function. The retrieval-augmented conversation room is managed as a data set in which the retrieval-augmented query generation unit 330 and the artificial intelligence conversation message generation unit 340 search and refer to past conversation history, and is utilized as a core element constituting the search target scope.

The retrieval-augmented interface unit 320 may provide a user interface for setting conditions to be used in the retrieval-augmented function, such as a search interval, a search topic, and a search category. The search interval may be set as a recent period or a specific period, and the search topic may be configured through a tag-based selection method or a text-based input method. The configured search options are stored as internal parameters, and are applied as filtering criteria when the retrieval-augmented query generation unit 330 generates a retrieval-augmented query.

The retrieval-augmented interface unit 320 may provide connection settings for a retrieval-augmented extension agent for expanding the retrieval-augmented function by interworking with an external database or an external knowledge repository. The retrieval-augmented extension agent may include various external information sources such as a document repository, a business database, and an enterprise internal knowledge repository, and the retrieval-augmented interface unit 320 may configure internal settings such that an extension information source selected by a user is included in the search scope.

The retrieval-augmented interface unit 320 may receive, in real time, an input for adding or removing a retrieval-augmented conversation room from a user, update a search conversation room set, and provide the updated search conversation room set to the retrieval-augmented query generation unit 330. In addition, when search configuration values including a retrieval-augmented conversation room, search options, and an extension agent are changed, the retrieval-augmented interface unit 320 may update internal parameters in cooperation with the control unit 360 such that the change is immediately reflected in the retrieval-augmented function.

The retrieval-augmented interface unit 320 integrates and manages upper-level control elements of the retrieval-augmented function, including definition of a search target scope, configuration of search options, and configuration of search sources, and may function as a core module that configures an overall search environment utilized in a retrieval-augmented query generation stage and an artificial intelligence conversation message generation stage.

In one embodiment according to the claims, the retrieval-augmented interface unit 320 may provide, through a UI executed on the user terminal 110, a list of conversation rooms in which the user participates in a table format. A user may select one or more conversation rooms to be utilized as a retrieval-augmented conversation room from the list. In addition, the retrieval-augmented interface unit 320 may provide a date input UI for designating a search interval, such as a calendar-based input, and a text input UI for designating a search topic. When a user changes the search interval or the search topic, the retrieval-augmented interface unit 320 may store the change as an internal configuration value, and may request the control unit 360 to generate a new artificial intelligence conversation room when the changed configuration conflicts with an existing artificial intelligence conversation room operation scheme.

In addition, the retrieval-augmented interface unit 320 may provide a user with a list of retrieval-augmented extension agents for connecting to an external database. A user may select a specific database connection module, and the selected retrieval-augmented extension agent may be applied to a search structure of the corresponding artificial intelligence conversation room. When a user requests cancellation of a retrieval-augmented conversation room, the retrieval-augmented interface unit 320 may update internal parameters so as to remove the corresponding conversation room from a search target set.

In an embodiment other than the claims, the retrieval-augmented interface unit 320 may analyze a recent conversation pattern of a user and may automatically recommend a search topic to be utilized for retrieval augmentation. The retrieval-augmented interface unit 320 may extract keywords repeatedly appearing among recent conversation messages stored in the user terminal 110 and may configure the extracted keywords as search topic candidates. For example, when phrases such as “contract,” “project schedule,” and “technical specification” appear at or above a predetermined ratio in user conversation messages, the retrieval-augmented interface unit 320 may present the phrases to a user as a list of search topic candidates. When the user selects a recommended search topic, the retrieval-augmented interface unit 320 may store the selected search topic as a search configuration value and may interwork the configuration such that the retrieval-augmented query generation unit 330 utilizes the configuration in a query generation process. As a result, the retrieval-augmented interface unit 320 may improve convenience of a search configuration process and search accuracy through automatic recommendation even when the user does not directly input a search topic.

In another embodiment, the retrieval-augmented interface unit 320 may analyze a conversation flow of a user or a specific task context and may automatically recommend a candidate conversation room to be utilized as a retrieval-augmented conversation room. The retrieval-augmented interface unit 320 may extract unique identification elements such as a project name, a person in charge name, or a document title from recent user conversation messages, and may search for an existing conversation room including the same element to display the existing conversation room as a retrieval-augmented conversation room candidate. For example, when a user inputs a message related to “adjustment of A project schedule,” the retrieval-augmented interface unit 320 may automatically identify a conversation room in which “A project” was mentioned in the past, include the identified conversation room in a list of retrieval-augmented conversation room candidates, and provide the list to the user. As a result, since the user can receive an automatic recommendation of a highly relevant conversation room without directly searching for the conversation room, a retrieval-augmented configuration process may be simplified and search quality may be improved.

In still another embodiment, the retrieval-augmented interface unit 320 may configure an advanced search configuration interface that provides additional filter conditions in addition to a search interval and a search topic. The retrieval-augmented interface unit 320 may provide, to the user terminal 110, a multi-filtering UI including a participant condition, a message type condition, and an importance tag condition. For example, a user may select one or more of the following conditions: a participant filter for searching only messages including a specific user, a message type filter for searching only messages including a document link or an image, and an importance-based filter for searching only messages to which an importance tag is assigned. The retrieval-augmented interface unit 320 may store the selected multi-filter conditions as internal configuration values and may transmit the conditions so as to be reflected in a conversation history search process of the retrieval-augmented query generation unit 330. As a result, the retrieval-augmented interface unit 320 may enable high-precision search-based response generation by finely adjusting a search scope even in a complex business environment.

Additionally, the retrieval-augmented interface unit 320 may dynamically adjust search settings based on user schedule information, location information, or device environment information. The retrieval-augmented interface unit 320 may automatically configure a search environment by referring to schedule data, location data, and device state information provided from the user terminal 110. For example, when a user accesses an artificial intelligence conversation room during a meeting time registered in a calendar schedule, the retrieval-augmented interface unit 320 may automatically present, as retrieval-augmented candidates, conversation rooms including meeting minutes or meeting-related tags. In addition, when a pattern is detected in which a user's work messages are concentrated in a specific time period, such as immediately after starting work, the retrieval-augmented interface unit 320 may automatically set the search interval to “the most recent one day.” When a user accesses via a mobile device, the retrieval-augmented interface unit 320 may be configured to switch search options to a simplified mode so as to display only a minimum number of selection items. As a result, the retrieval-augmented interface unit 320 may adaptively respond to a user situation to automate search configuration, and may greatly improve search efficiency and user convenience.

The retrieval-augmented query generation unit 330 may perform a function of analyzing a conversation message input from a user in an artificial intelligence conversation room and generating a retrieval-augmented query for searching past conversation history of a retrieval-augmented conversation room. The retrieval-augmented query generation unit 330 may refer to search configuration values such as a search topic, a search interval, and a search category set by the retrieval-augmented interface unit 320, determine whether the user message falls within a search target scope, and determine whether to generate a retrieval-augmented query and a generation format thereof based on a result of the determination.

The retrieval-augmented query generation unit 330 may analyze semantic elements of a user message, including a topic, an entity name, time information, a task unit, and a contextual expression, and may configure a core query to be utilized in a retrieval-augmented function. The retrieval-augmented query generation unit 330 may apply analysis techniques such as named entity recognition, text extraction (OCR), and object recognition not only to a text message but also to unstructured data such as a file, an image, a video, and a voice input, derive semantic core elements, and convert the semantic core elements into a retrieval-augmented query.

When it is determined in a retrieval-augmented query generation process that a search result is inappropriate or relevance to a search configuration value is insufficient, the retrieval-augmented query generation unit 330 may check whether another artificial intelligence conversation room having a search topic correlated outside the retrieval-augmented conversation room exists, and may determine an artificial intelligence conversation agent 311 participating in the other artificial intelligence conversation room as a candidate for auxiliary query processing. When an auxiliary query is required, the retrieval-augmented query generation unit 330 may select one of a method of performing a single-use query request to the artificial intelligence conversation agent 311 and a method of configuring a cooperative structure in which continuous responses are possible in a new conversation room.

The retrieval-augmented query generation unit 330 may transmit, together with a finally generated retrieval-augmented query, metadata including search target conversation room information, search options, and filtering criteria to the artificial intelligence conversation message generation unit 340. The transmitted retrieval-augmented query and metadata are referenced when the artificial intelligence conversation message generation unit 340 configures an integrated input prompt, and may be utilized as basic data for selecting conversation blocks corresponding to a search target scope among past conversation history of the retrieval-augmented conversation room. Through such data processing procedures, the retrieval-augmented query generation unit 330 may accurately reflect semantic characteristics of a user message and search configuration values, thereby performing a function of increasing precision of a search-based artificial intelligence response.

In one embodiment according to the claims, the retrieval-augmented query generation unit 330 may analyze a conversation message input from the user terminal 110 and may determine whether a semantic topic of the message is included in a search topic designated by the retrieval-augmented interface unit 320. When it is determined that the semantic topic is included in the search topic, the retrieval-augmented query generation unit 330 may extract core words, contextual expressions, and mentioned entity names from the user message and may generate a retrieval-augmented query for searching past conversation history in the retrieval-augmented conversation room. When generation of the retrieval-augmented query fails, the retrieval-augmented query generation unit 330 may analyze a cause of failure of the retrieval-augmented query generation and may check whether another artificial intelligence conversation room having an identical or similar search topic exists. In this case, the retrieval-augmented query generation unit 330 may determine whether to request support from another artificial intelligence conversation agent 311. For example, when a user message corresponds to a topic of “technical review request” but past history of the topic is insufficient in a current retrieval-augmented conversation room, the retrieval-augmented query generation unit 330 may search for another artificial intelligence conversation room having a technical review-related search topic and may select one of a temporary query request and invitation-based continuous participation for the corresponding artificial intelligence conversation agent 311.

In an embodiment other than the claims, the retrieval-augmented query generation unit 330 may generate a retrieval-augmented query by extracting semantic elements not only from a text message but also from unstructured data such as a file, an image, a video, and a voice input. The retrieval-augmented query generation unit 330 may analyze entity names, repeated terms, and major visual information included in the unstructured data, evaluate whether the analyzed information matches a search topic, and configure an appropriate retrieval-augmented query. For example, when a user uploads a technical document file, the retrieval-augmented query generation unit 330 may analyze a file name, internal item names, or visual notation elements and may derive query candidates such as “technical specification,” “implementation configuration,” and “performance requirement.” When an image is input, the retrieval-augmented query generation unit 330 may extract text and device names within the image through OCR or object recognition processing, determine relevance to a search topic, and generate a query. In addition, the retrieval-augmented query generation unit 330 may generate an integrated query by combining semantic elements extracted from different input formats. For example, the retrieval-augmented query generation unit 330 may automatically configure a high-precision retrieval-augmented query such as “A project meeting minutes” by combining a project name extracted from an image and a request intent identified from a text message. As a result, the retrieval-augmented query generation unit 330 may stably maintain quality of semantic-based query generation even in a conversation environment including unstructured data, and may be effectively applied even in an environment in which complex information is mixed, such as technical document processing or business material search.

In another embodiment, when it is determined that retrieval-augmented query generation fails or relevance to a search topic is insufficient, the retrieval-augmented query generation unit 330 may evaluate topic similarity among user-participating conversation rooms and may search for an alternative search target. The retrieval-augmented query generation unit 330 may automatically include another conversation room having high similarity in a candidate group when sufficient search history is not secured in an existing retrieval-augmented conversation room. The retrieval-augmented query generation unit 330 may generate query candidates based on a plurality of conversation room topics for a single user message to supplement or expand a search scope. For example, the retrieval-augmented query generation unit 330 may generate query candidates reflecting different conversation room topics such as a project schedule, a contract change record, and a meeting minutes summary for the same message. In addition, the retrieval-augmented query generation unit 330 may determine whether to request support from another artificial intelligence conversation agent 311 participating in a candidate conversation room. When necessary, the retrieval-augmented query generation unit 330 may temporarily utilize the artificial intelligence conversation agent 311 for query processing, or may configure a new artificial intelligence conversation room to enable continuous support in an environment requiring long-term conversation cooperation. As a result, the retrieval-augmented query generation unit 330 may automatically expand a search target even in a search failure situation and may support auxiliary query execution using multiple agents, thereby increasing reliability and flexibility of search-based response generation even in a complex business environment.

The artificial intelligence conversation message generation unit 340 may search past conversation history of a retrieval-augmented conversation room based on a retrieval-augmented query generated by the retrieval-augmented query generation unit 330, and may configure an integrated input prompt to be input to the artificial intelligence conversation agent 311 by using searched conversation blocks and a user conversation message. The integrated input prompt refers to a standardized input object in which a user message, a retrieval-augmented query, conversation blocks selected from the retrieval-augmented conversation room, response evidence links corresponding to the respective conversation blocks, and metadata required for response generation are integrated into a single structured input set, and functions as a unit for providing context, sources, and search information required in a process in which the artificial intelligence conversation agent 311 generates a response in a consistent format.

The artificial intelligence conversation message generation unit 340 may evaluate keyword matching degree, occurrence time, message type, and the like for the searched conversation blocks, and may select conversation blocks having high relevance to the user message. A response evidence link including a unique identifier, a conversation time point, and participant information may be generated and assigned to each of the selected conversation blocks, and the response evidence link may be utilized as reference evidence data that the artificial intelligence conversation agent 311 refers to during response generation within the integrated input prompt. The artificial intelligence conversation message generation unit 340 may generate a final structure of the integrated input prompt by combining the user message, the retrieval-augmented query, and the selected conversation blocks, and may configure the integrated input prompt in a normalized format.

In addition, the artificial intelligence conversation message generation unit 340 may receive an artificial intelligence conversation message generated by the artificial intelligence conversation agent 311 and may control the artificial intelligence conversation message to be provided to a user by transmitting the artificial intelligence conversation message to the artificial intelligence conversation response unit 350. The artificial intelligence conversation message may include a response evidence link, and when a user selects the link, an interaction function may be supported such that content of a corresponding conversation block can be immediately checked.

The artificial intelligence conversation message generation unit 340 may apply a prompt optimization policy for maintaining quality of input data in a process of configuring the integrated input prompt. When an amount or length of searched conversation blocks exceeds a predetermined criterion, the artificial intelligence conversation message generation unit 340 may normalize the conversation blocks to limit a number of input tokens in consideration of processing efficiency of the artificial intelligence conversation agent 311. The artificial intelligence conversation message generation unit 340 may also be configured to extract core sentences by topic and reflect the extracted core sentences in a summarized form in the integrated input prompt. Through such structural control, the artificial intelligence conversation message generation unit 340 may maintain core context required for response generation while preventing accumulation of unnecessary information.

The artificial intelligence conversation message generation unit 340 may filter out messages having low semantic contribution or corresponding to noise among the searched conversation blocks and may exclude the messages from the prompt. The noise messages may include greeting expressions, interjections, emoji-centered messages, and non-business conversations, and through such filtering, the artificial intelligence conversation message generation unit 340 may refine an input environment such that the artificial intelligence conversation agent 311 generates a more meaning-based response.

In addition, the artificial intelligence conversation message generation unit 340 may support an access control and security setting function for response evidence links. When a specific conversation block includes sensitive information or corporate confidential information, the artificial intelligence conversation message generation unit 340 may apply a security policy by restricting access to the link after checking user authority or by providing a guidance message when authority is insufficient.

In one embodiment according to the claims, the artificial intelligence conversation message generation unit 340 may receive a retrieval-augmented query from the retrieval-augmented query generation unit 330 as an input. The artificial intelligence conversation message generation unit 340 may select conversation blocks matching the query from past conversation history of the retrieval-augmented conversation room by using the retrieval-augmented query. A response evidence link including a unique identifier and conversation time point information may be assigned to each of the selected conversation blocks, and the response evidence links may be included in configuration of the integrated input prompt.

In another embodiment, the artificial intelligence conversation message generation unit 340 may generate a structured integrated input prompt interpretable by the artificial intelligence conversation agent 311 by integrating a user conversation message and a retrieval-augmented query. For example, the artificial intelligence conversation message generation unit 340 may configure a structured template such as “user request summary→related conversation blocks→response evidence links→expected response format.” The artificial intelligence conversation agent 311 may receive the template-based prompt as an input and may generate an artificial intelligence conversation message consistent with the user message, and the generated message may be transmitted to the artificial intelligence conversation response unit 350 together with response evidence links by the artificial intelligence conversation message generation unit 340.

In an embodiment other than the claims, the artificial intelligence conversation message generation unit 340 may dynamically adjust importance weights based on recency of conversation blocks. Among past conversation blocks including the same keyword, the artificial intelligence conversation message generation unit 340 may assign higher importance to messages occurring at a more recent time point and may reflect the messages in configuration of the integrated input prompt. For example, when a retrieval-augmented query is “A project schedule,” if a recent meeting minutes message and an older related message are simultaneously searched, the artificial intelligence conversation message generation unit 340 may configure the recent meeting minutes message as a higher-priority conversation block. Through this configuration, the artificial intelligence conversation agent 311 may generate a response more accurately matching user intent.

In another embodiment, when a plurality of searched conversation blocks exist, the artificial intelligence conversation message generation unit 340 may generate a “compressed conversation context” obtained by grouping and summarizing the conversation blocks by topic. The artificial intelligence conversation message generation unit 340 may cluster repeated topics, discussions based on the same document, or issue processing flows among the searched conversation blocks, generate a summary sentence for each topic, and include the summary sentence in the integrated input prompt. For example, when eight conversation blocks corresponding to the same topic of “project schedule delay” exist, the artificial intelligence conversation message generation unit 340 may generate a compressed context such as “summary of discussions on causes of schedule delay over the past three weeks” by integrating the eight messages. A configuration applying the integrated input prompt may maintain structuring of input information even in a corporate collaboration environment having a large scale of conversation data or a long-term project environment, thereby supporting the artificial intelligence conversation agent 311 to generate stable and consistent responses.

The artificial intelligence conversation response unit 350 may receive an artificial intelligence conversation message generated by the artificial intelligence conversation agent 311 and may perform a function of providing the artificial intelligence conversation message through a user interface of an artificial intelligence conversation room. During a process of providing the message, the artificial intelligence conversation response unit 350 may detect a user's editing intent, and may support a function of directly modifying the artificial intelligence conversation message or correcting a user input message and requesting regeneration, according to an editing method selected by the user.

The artificial intelligence conversation response unit 350 may provide an editing interface that allows a user to directly modify a sentence or specific content of the artificial intelligence conversation message. When the user performs direct editing, the artificial intelligence conversation response unit 350 may immediately reflect the modified message in a record of the artificial intelligence conversation room and store the modified message as a final message, and in this process, additional computation of the artificial intelligence conversation agent 311 may not be performed.

When the user desires to change the artificial intelligence conversation message by modifying the user's own input message, the artificial intelligence conversation response unit 350 may control the modified user message to be transmitted again to the artificial intelligence conversation agent 311 so as to generate a new artificial intelligence conversation message. Such an indirect editing-based regeneration method may be utilized to reconstruct the existing artificial intelligence conversation message in a corrected form by reflecting the user's modification intent.

The artificial intelligence conversation response unit 350 may display a response evidence link included in the artificial intelligence conversation message to the user, and when the user selects the response evidence link, the artificial intelligence conversation response unit 350 may support provision of a corresponding conversation block in a separate window or pop-up form so that a basis for generation of the artificial intelligence conversation message can be checked.

The artificial intelligence conversation response unit 350 may perform a function of controlling an editable range by referring to user authority, conversation room settings, and security policies. In a collaboration environment in which direct editing is restricted, the artificial intelligence conversation response unit 350 may activate and apply only an indirect editing method.

In addition, the artificial intelligence conversation response unit 350 may apply different processing paths according to a user's editing method. When the user directly modifies the artificial intelligence conversation message, the artificial intelligence conversation response unit 350 may perform a direct editing path in which the modified message is immediately reflected in a conversation record. On the other hand, when the user modifies the user's own conversation message and requests a new artificial intelligence conversation message, the artificial intelligence conversation response unit 350 may perform an indirect editing path in which the modified user message is transmitted to the artificial intelligence conversation agent 311 and a regenerated message replaces an existing message. Such a path classification structure may be configured to select an appropriate processing procedure according to a type of user editing, thereby performing a role of securing both accuracy of response editing and processing efficiency.

In one embodiment according to the claims, the artificial intelligence conversation response unit 350 may display an artificial intelligence conversation message provided by the artificial intelligence conversation message generation unit 340 on the user terminal 110. During a message display process, the artificial intelligence conversation response unit 350 may detect a user editing request, and when the user intends to directly modify the message, may convert message content into an editable form and reflect user input. In addition, when the user modifies the user's own conversation message, the artificial intelligence conversation response unit 350 may transmit the modified message to the artificial intelligence conversation agent 311 so as to control generation of a new artificial intelligence conversation message. The generated message may be provided to the user in a manner of replacing an existing artificial intelligence conversation message.

In an embodiment other than the claims, the artificial intelligence conversation response unit 350 may provide editing options that allow a user to adjust expressive attributes such as a style, a tone, a length, and a language used in a response. When the user selects a request such as “make it more concise,” “change to a literary style,” or “lower a level of technical terminology,” the artificial intelligence conversation response unit 350 may transmit the selected option to the artificial intelligence conversation agent 311 to perform a regeneration request, and may provide an artificial intelligence conversation message in an adjusted format. As a result, the artificial intelligence conversation response unit 350 may allow the user to easily adjust the artificial intelligence conversation message into a desired form, thereby increasing efficiency of conversation and expression customization.

In another embodiment, the artificial intelligence conversation response unit 350 may manage an editing history of an artificial intelligence conversation message and may provide a function that allows a user to roll back to a previous version of the message. The artificial intelligence conversation response unit 350 may record a message version at each modification step, and when the user selects “view previous message” or “restore original message,” may be configured to display the corresponding version again in the artificial intelligence conversation room. As a result, the artificial intelligence conversation response unit 350 may be usefully applied in terms of response quality management and record preservation in a collaboration environment in which long-term and repetitive work records are important.

The control unit 360 may perform a central control function of managing data flow and an operation sequence among the artificial intelligence conversation room generation unit 310, the retrieval-augmented interface unit 320, the retrieval-augmented query generation unit 330, the artificial intelligence conversation message generation unit 340, and the artificial intelligence conversation response unit 350 that constitute the artificial intelligence conversation processing apparatus 130. The control unit 360 may receive event information, request information, and state information generated in each unit, and may perform control procedures such as inter-module linkage processing, step transition, internal parameter synchronization, and data transmission path configuration based on the received information.

The control unit 360 may coordinate operations of each unit so that an overall operation of the artificial intelligence conversation processing apparatus 130 can be stably performed according to defined procedures. For example, the control unit 360 may control retrieval-augmented conversation room information set by the retrieval-augmented interface unit 320 to be timely delivered to the retrieval-augmented query generation unit 330, or may process an artificial intelligence conversation message generated by the artificial intelligence conversation message generation unit 340 to be accurately linked to the artificial intelligence conversation response unit 350. In addition, the control unit 360 may monitor a processing state of each unit to perform a recovery procedure when an error occurs, or may reconfigure a data transmission path to secure stability of the entire apparatus.

The control unit 360 may perform control functions such as protocol management, message transmission timing adjustment, and internal storage parameter updating in a process of communication and data transmission with the user terminal 110. The control unit 360 may also manage control tasks occurring across the apparatus, such as generation of a new conversation room, reflection of changes in retrieval-augmented settings, and processing of a response regeneration request, according to a consistent policy when necessary.

As a result, the control unit 360 may function as a core control layer that oversees overall control procedures so that all units of the artificial intelligence conversation processing apparatus 130 can be interlinked and operate harmoniously.

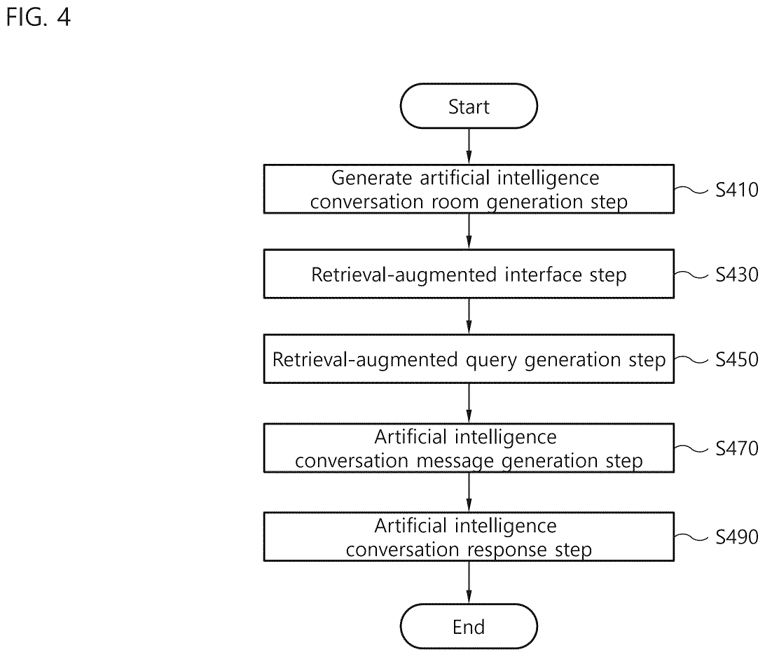

FIG. 4 is a flowchart illustrating an artificial intelligence conversation processing method performed in the artificial intelligence conversation processing apparatus of FIG. 1.

Referring to FIG. 4, the artificial intelligence conversation processing apparatus 130 performs an artificial intelligence conversation processing procedure, and the procedure includes an artificial intelligence conversation room generation step S410, a retrieval-augmented interface step S430, a retrieval-augmented query generation step S450, an artificial intelligence conversation message generation step S470, and an artificial intelligence conversation response step S490.

In the artificial intelligence conversation room generation step S410, the artificial intelligence conversation processing apparatus 130 may generate an artificial intelligence conversation room in which the artificial intelligence conversation agent 311 capable of responding to a user conversation participates. The artificial intelligence conversation processing apparatus 130 may receive a conversation room generation request from the user terminal 110 and may configure an artificial intelligence conversation room in which the artificial intelligence conversation agent 311 is registered as an initial participant according to the request.

In the retrieval-augmented interface step S430, the artificial intelligence conversation processing apparatus 130 may generate a retrieval-augmented interface for setting a retrieval-augmented conversation room through the retrieval-augmented interface unit 320. The retrieval-augmented interface may provide a UI environment in which a user can set a specific conversation room as a retrieval-augmented conversation room among a plurality of conversation rooms in which the user participates, and may receive inputs of a search interval, a search topic, and retrieval-augmented extension agent settings to configure search targets referenced in the retrieval-augmented query generation step S450 and the artificial intelligence conversation message generation step S470.

In the retrieval-augmented query generation step S450, the artificial intelligence conversation processing apparatus 130 may analyze a user conversation message through the retrieval-augmented query generation unit 330 and may generate a retrieval-augmented query for searching past conversation history of the retrieval-augmented conversation room. The artificial intelligence conversation processing apparatus 130 may determine whether the user message belongs to a search topic set in the retrieval-augmented interface, may determine whether to generate the retrieval-augmented query according to a determination result, and may evaluate availability of a topic-similar conversation room when query generation fails.

In the artificial intelligence conversation message generation step S470, the artificial intelligence conversation processing apparatus 130 may search past conversation history of the retrieval-augmented conversation room by applying the generated retrieval-augmented query, and may configure an integrated input prompt based on conversation blocks selected as search results and the user conversation message. The configured integrated input prompt is a standardized input set composed of the user message, the retrieval-augmented query, the selected conversation blocks, response evidence links, and related metadata, and may be input to the artificial intelligence conversation agent 311 and utilized to generate a final artificial intelligence conversation message.

In the artificial intelligence conversation response step S490, the artificial intelligence conversation processing apparatus 130 may provide, to an artificial intelligence conversation room, the artificial intelligence conversation message generated by the artificial intelligence conversation agent 311. The artificial intelligence conversation processing apparatus 130 may display, to a user, the artificial intelligence conversation message including response evidence links, and may support editing functions that allow the user to directly modify message content or indirectly correct a response by rewriting the user message.

As a result, the artificial intelligence conversation processing procedure of FIG. 4 has a structure in which the artificial intelligence conversation room generation step S410, the retrieval-augmented interface step S430, the retrieval-augmented query generation step S450, the artificial intelligence conversation message generation step S470, and the artificial intelligence conversation response step S490 are sequentially linked, and illustrates an overall operation process in which the artificial intelligence conversation processing apparatus 130 enhances search-based responses and improves a conversation flow based on user utterances.

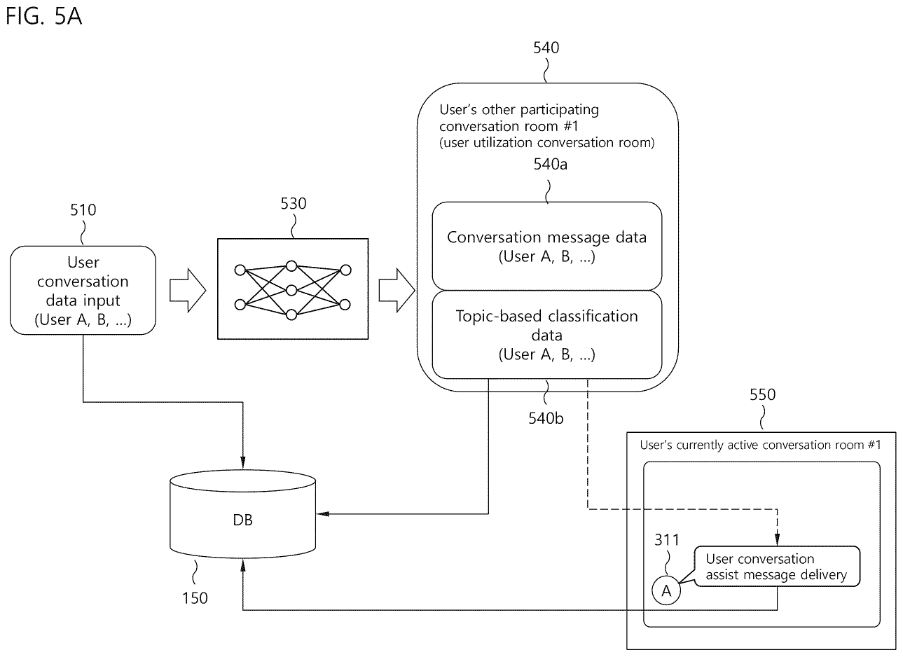

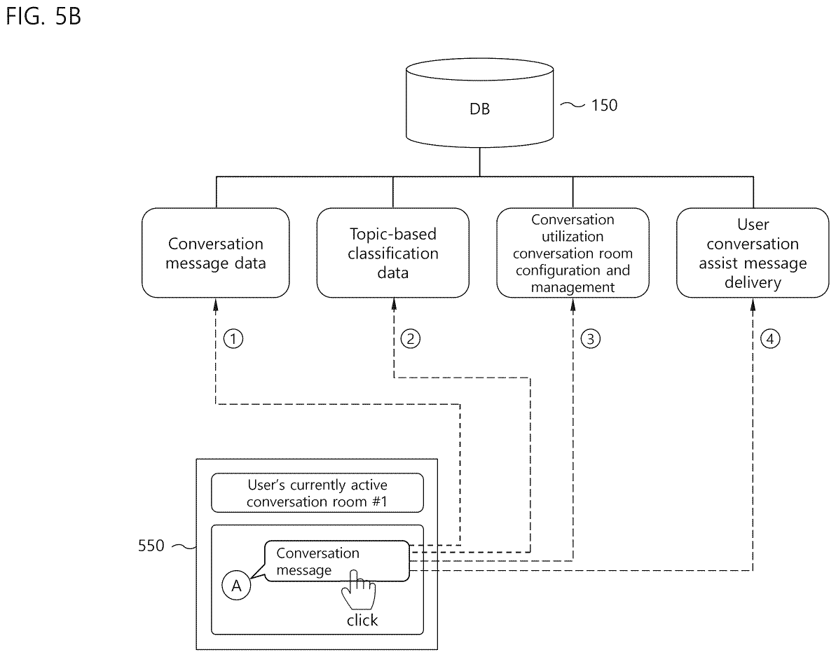

FIGS. 5A and 5B are diagrams illustrating a process of generating and utilizing conversation data in the artificial intelligence conversation processing apparatus of FIG. 1.

FIG. 5A illustrates a structure for processing and storing user conversation data, and FIG. 5B illustrates a data utilization interface structure in a current conversation room.

Referring to FIGS. 5A and 5B, the artificial intelligence conversation processing apparatus 130 may receive user conversation data 510 and generate and manage conversation message data 540a and topic-based classification data 540b by using a user conversation assistant model 530 configured to execute an artificial intelligence conversation agent 311. The generated data may be utilized as reference data for context analysis of a participating conversation room 540 selected by a user, generation of retrieval-augmented queries, and generation of artificial intelligence conversation messages.

FIG. 5A is a diagram for explaining a process in which the artificial intelligence conversation processing apparatus 130 generates and stores conversation message data 540a and topic-based classification data 540b based on user conversation data. The artificial intelligence conversation processing apparatus 130 may receive the user conversation data 510 as input and generate the conversation message data 540a and the topic-based classification data 540b by using the user conversation assistant model 530 composed of an interworking model of the artificial intelligence conversation agent 311. The conversation message data 540a includes original text of user utterances, and the topic-based classification data 540b is configured as a data structure for classifying and storing specific topics, work units, and category information included in user conversations.

The generated conversation message data 540a and topic-based classification data 540b are stored in the database 150, and the stored data may be referenced in a context analysis of the participating conversation room 540 selected by the user, generation of retrieval-augmented queries, and generation of artificial intelligence conversation messages. In addition, the artificial intelligence conversation processing apparatus 130 may analyze the user conversation data 510 in real time through the user conversation assistant model 530 and automatically update the generated conversation message data 540a and topic-based classification data 540b so that the data can be retrieved and searched in the participating conversation room 540 selected by the user, that is, a retrieval-augmented target conversation room.

FIG. 5A illustrates a data processing flow in which the user conversation data 510 is processed by the user conversation assistant model 530 and the results are stored in the form of the conversation message data 540a and the topic-based classification data 540b, which are referenced by the retrieval-augmented query generation unit 330 and the artificial intelligence conversation message generation unit 340.

FIG. 5B is a diagram for explaining a process in which the artificial intelligence conversation processing apparatus 130 provides conversation data retrieval and assistant messages centered on a current conversation room 550. The current conversation room 550 is configured as an active conversation interface in which user input messages are processed in real time, and may include an area in which artificial intelligence conversation messages generated by the artificial intelligence conversation agent 311 are displayed. The conversation message data 540a and the topic-based classification data 540b stored in the participating conversation room 540 selected by the user may be selectively linked to the current conversation room 550.

When a user selects a specific sentence or topic element in the current conversation room 550, the artificial intelligence conversation processing apparatus 130 may query corresponding data 540a and 540b stored in the database 150 and provide original text or related information. For example, when a user inputs a query such as “show previous discussions of Project X” in the current conversation room 550, the artificial intelligence conversation processing apparatus 130 may search the conversation message data 540a of the participating conversation room 540 selected by the user and provide key content to the current conversation room 550 in the form of a summarized or refined artificial intelligence conversation message.

FIG. 5B illustrates that the current conversation room 550 can simultaneously perform real-time conversation functions and information retrieval functions based on past conversation data, and illustrates an overall operation flow in which the artificial intelligence conversation processing apparatus 130 provides retrieval-augmented conversation assist functions in conjunction with the participating conversation room 540 and the database 150.

In conclusion, FIGS. 5A and 5B jointly illustrates (1) a structure for generation, classification, and storage processing of user conversation data 510 (FIG. 5A) and (2) a UI processing structure in which retrieval-augmented queries and artificial intelligence responses are provided centered on the current conversation room 550 (FIG. 5B). Through this, an overall processing flow is described in which the artificial intelligence conversation processing apparatus 130 organically interworks the user conversation assistant model 530, the participating conversation room 540, the database 150, and the current conversation room 550 to perform retrieval-augmented artificial intelligence conversation functions.

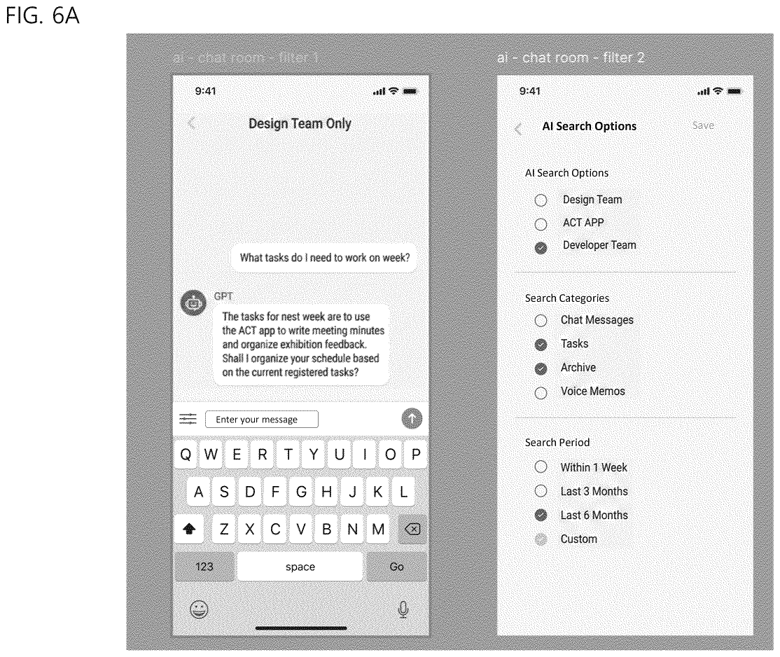

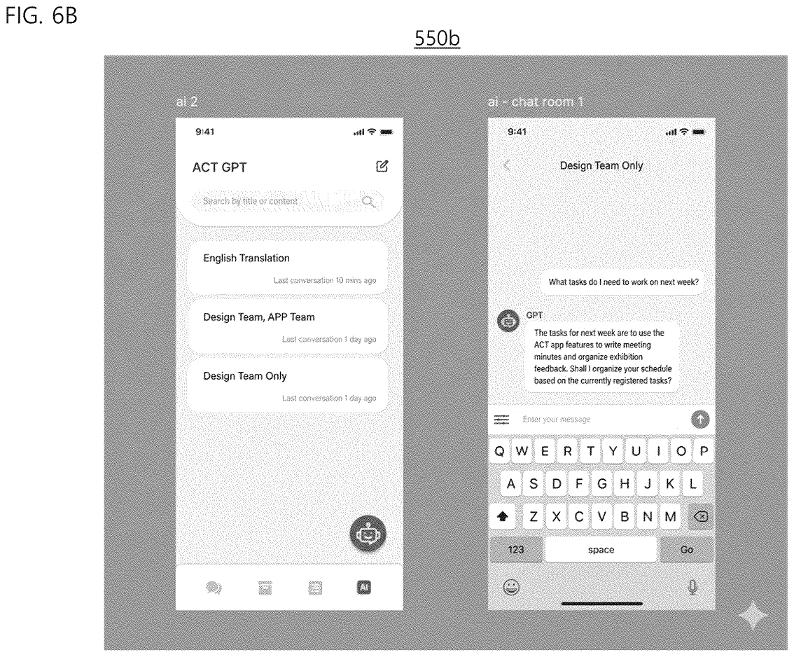

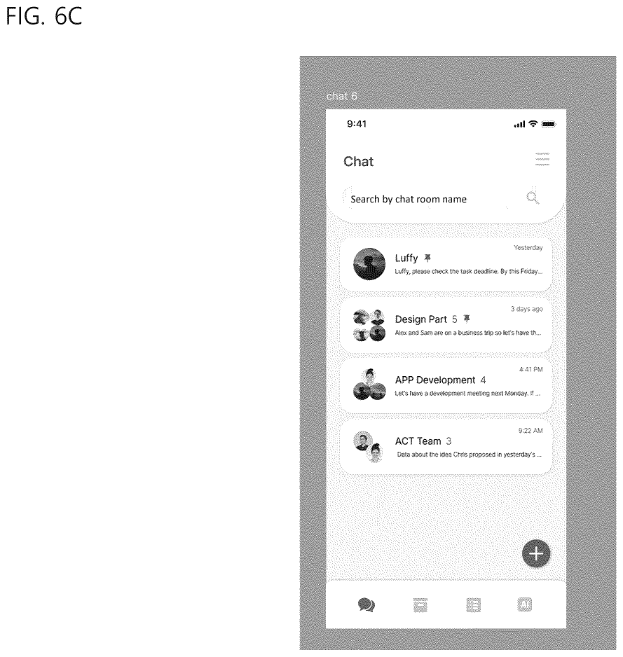

FIGS. 6A to 6C are diagrams illustrating an example of a user interface (UI) configuration implemented in the artificial intelligence conversation processing apparatus of FIG. 1.

FIG. 6A illustrates an artificial intelligence conversation room screen and a retrieval-augmented option setting screen, FIG. 6B illustrates an artificial intelligence conversation room list screen and a current conversation room screen, and FIG. 6C illustrates a participating conversation room list screen.

FIG. 6A illustrates a configuration of an artificial intelligence conversation room screen and a retrieval-augmented option setting screen.

Here, the artificial intelligence conversation room screen refers to a user interface screen that displays a current conversation room 550 in which a user actually performs conversations.

Referring to FIG. 6A, the current conversation room 550 is configured as a conversation interface in which the artificial intelligence conversation agent 311 participates and provides responses with respect to a specific conversation topic selected or activated by the user. In the current conversation room 550, conversation messages input by the user and artificial intelligence conversation messages generated by the artificial intelligence conversation agent 311 may be displayed in real time. When a retrieval-augmented function is activated, data of the participating conversation room 540 may be referenced and reflected in a message generation process.

FIG. 6B illustrates an example of an artificial intelligence conversation room list screen and a current conversation room screen.

Referring to FIG. 6B, the artificial intelligence conversation room generation unit 310 may provide a plurality of artificial intelligence conversation histories in a list form, and the user may select one of the listed conversation histories to set the current conversation room 550 based on the selected conversation history. The set current conversation room 550 is displayed through the artificial intelligence conversation room screen, and a conversation may proceed in a state in which the artificial intelligence conversation agent 311 automatically participates.

FIG. 6C illustrates a configuration of a participating conversation room list screen.

Referring to FIG. 6C, the participating conversation room 540 is configured as a past conversation room or a user-defined conversation room that is referenceable for retrieval-augmented artificial intelligence response generation, and a plurality of participating conversation rooms 540 may be provided in a list form. The user may select one or more participating conversation rooms 540 from the list as retrieval-augmented targets, and conversation message data included in the selected participating conversation rooms 540 may be utilized as reference data in a process of generating artificial intelligence conversation messages in the current conversation room 550.

FIGS. 6A to 6C illustrate an example of a UI configuration implemented by the artificial intelligence conversation processing apparatus 130 in the user terminal 110. FIG. 6A illustrates an artificial intelligence conversation room screen displaying the current conversation room 550 and a retrieval-augmented option setting screen, FIG. 6B illustrates a screen in which an artificial intelligence conversation room list screen and the current conversation room 550 are displayed in an interworking manner, and FIG. 6C illustrates a list screen of participating conversation rooms 540 utilized for retrieval augmentation.

This configuration explains how the artificial intelligence conversation processing apparatus 130 interworks the current conversation room 550, the participating conversation room 540, and a retrieval-augmented setting UI in order to provide retrieval-augmented artificial intelligence responses.

Although the preferred embodiments of the present invention have been described above, those skilled in the art will understand that various modifications and changes may be made to the present invention without departing from the spirit and scope of the present invention as set forth in the appended claims.

### DETAILED DESCRIPTION OF MAIN ELEMENTS

100: artificial intelligence conversation processing system
110: user terminal
130: artificial intelligence conversation processing apparatus
150: database
210: processor
230: memory
250: user input/output unit
270: network input/output unit
290: communication port unit
310: artificial intelligence conversation room generation unit
311: artificial intelligence conversation agent
320: retrieval-augmented interface unit
330: retrieval-augmented query generation unit
340: artificial intelligence conversation message generation unit
350: artificial intelligence conversation response unit
360: control unit
510: user conversation data
530: user conversation assistant model
540: participating conversation room selected by a user
540a: conversation message data
540b: topic-based classification data
550: current conversation room

What is claimed is:

1. An artificial intelligence conversation processing apparatus comprising:
an artificial intelligence conversation room generation unit configured to generate an artificial intelligence conversation room in which an artificial intelligence conversation agent capable of responding to a user's conversation participates;
a retrieval-augmented interface unit configured to generate a retrieval-augmented interface for setting a retrieval-augmented conversation room to be utilized in the artificial intelligence conversation room, wherein the retrieval-augmented conversation room is configured as a participating conversation room of the user;
a retrieval-augmented query generation unit configured to receive a user conversation message in the artificial intelligence conversation room and to generate a retrieval-augmented query that can be utilized to search past conversation history of the retrieval-augmented conversation room;
an artificial intelligence conversation message generation unit configured to search the past conversation history of the retrieval-augmented conversation room through the retrieval-augmented query and to input the user conversation message and the searched past conversation history to the artificial intelligence conversation agent as an integrated input prompt to generate an artificial intelligence conversation message; and
an artificial intelligence conversation response unit configured to provide the artificial intelligence conversation message to the artificial intelligence conversation room as a response to the user conversation message by the artificial intelligence conversation agent.

2. The artificial intelligence conversation processing apparatus of claim 1, wherein the artificial intelligence conversation agent is invited by the user so as to simultaneously participate in another participating conversation room of the user.

3. The artificial intelligence conversation processing apparatus of claim 1, wherein the retrieval-augmented interface unit is configured to set a search interval or a search topic for the retrieval-augmented conversation room through the retrieval-augmented interface.

4. The artificial intelligence conversation processing apparatus of claim 1, wherein the retrieval-augmented interface unit is configured to connect a retrieval-augmented extension agent that controls searching and answering with respect to an external database through the retrieval-augmented interface.

5. The artificial intelligence conversation processing apparatus of claim 1, wherein the retrieval-augmented interface unit is configured to generate a new artificial intelligence conversation room when a search interval or a search topic for the retrieval-augmented conversation room is changed through the retrieval-augmented interface, or when the retrieval-augmented extension agent is changed.

6. The artificial intelligence conversation processing apparatus of claim 1, wherein the retrieval-augmented interface unit is configured to add or cancel the retrieval-augmented conversation room through the retrieval-augmented interface.

7. The artificial intelligence conversation processing apparatus of claim 1, wherein the retrieval-augmented query generation unit is configured to determine whether the user conversation message belongs to a search topic of the retrieval-augmented conversation room and to determine whether to generate the retrieval-augmented query based on the determination.

8. The artificial intelligence conversation processing apparatus of claim 7, wherein, when generation of the retrieval-augmented query fails, the retrieval-augmented query generation unit is configured to determine whether to receive support from another artificial intelligence conversation agent in another artificial intelligence conversation room set to another search topic having relevance to the retrieval-augmented query.

9. The artificial intelligence conversation processing apparatus of claim 1, wherein the artificial intelligence conversation message generation unit is configured to select a conversation block corresponding to the retrieval-augmented query from the past conversation history of the retrieval-augmented conversation room, to assign a response evidence link to the selected conversation block, and to utilize the conversation block and the response evidence link in generation of the integrated input prompt.

10. The artificial intelligence conversation processing apparatus of claim 9, wherein the artificial intelligence conversation message generation unit is configured to provide the artificial intelligence conversation message together with the response evidence link through the artificial intelligence conversation agent and to allow contents of the conversation block to be confirmed through user interaction.

11. The artificial intelligence conversation processing apparatus of claim 1, wherein the artificial intelligence conversation response unit is configured to directly modify the artificial intelligence conversation message through edit control of the user during a process of providing the artificial intelligence conversation message.

12. The artificial intelligence conversation processing apparatus of claim 1, wherein the artificial intelligence conversation response unit is configured to modify the user conversation message through edit control of the user during a process of providing the artificial intelligence conversation message so that the artificial intelligence conversation agent indirectly modifies the artificial intelligence conversation message.

13. A method for artificial intelligence conversation processing performed in an artificial intelligence conversation processing apparatus, the method comprising:
generating an artificial intelligence conversation room in which an artificial intelligence conversation agent capable of responding to a user's conversation participates;
generating a retrieval-augmented interface for setting a retrieval-augmented conversation room to be utilized in the artificial intelligence conversation room, wherein the retrieval-augmented conversation room is configured as a participating conversation room of the user;
receiving a user conversation message in the artificial intelligence conversation room and generating a retrieval-augmented query that can be utilized to search past conversation history of the retrieval-augmented conversation room;
searching the past conversation history of the retrieval-augmented conversation room through the retrieval-augmented query and inputting the user conversation message and the searched past conversation history to the artificial intelligence conversation agent as an integrated input prompt to generate an artificial intelligence conversation message; and
providing the artificial intelligence conversation message to the artificial intelligence conversation room as a response to the user conversation message by the artificial intelligence conversation agent.
